(19) United States
(12) Patent Application Publication
(10) Pub. No.: US 2010/0113110 A1
(43) Pub. Date: May 6, 2010

(54) LINK ASSEMBLY WITH SPRINGS WHICH CAN BE EXTENDED AND CONTRACTED AND SLIDER ASSEMBLY HAVING IT

(75) Inventor: Jang Woo Lee, Gyeonggi-do (KR)

Correspondence Address: LOWE HAUPTMAN HAM & BERNER, LLP, 1700 DIAGONAL ROAD, SUITE 300, ALEXANDRIA, VA, 22314, US

(73) Assignee: HITECH PARTS CO., LTD., Seoul (KR)

(21) Appl. No.: 12/594,795

(22) PCT Filed: Mar. 21, 2008
(86) PCT No.: PCT/KR08/01600

§ 371 Date: Oct. 21, 2009

(30) Foreign Application Priority Data
Apr. 6, 2007 (KR) 10-2007-0034303

(51) Int. Cl. H04M 1/00; F16H 21/54

(52) U.S. Cl. 455/575.4; 74/100.1

(57) ABSTRACT

An extendable and retractable link assembly is rotatably attached to a fixed plate and a sliding plate of a slide type cellular phone for applying a biasing force to the fixed plate and the sliding plate. The link assembly includes a link plate including a base end portion and at least one spring receiving channel extending from the base end portion. A link frame is coupled to the link plate in a removal-free manner, the link frame including a base end portion and at least one spring support rod extending into the spring receiving channel of the link plate. The link assembly further includes a spring having a first end received within the spring receiving channel of the link plate and a second end into which the spring support rod of the link frame is inserted.

### FIELD OF THE INVENTION

The present invention relates to an extendable and retractable link assembly with springs and a slider assembly for a slide type cellular phone having the same and, more particularly, to a thickness-reduced link assembly capable of making a cellular phone slim and a slider assembly having the same.

### BACKGROUND ART

Referring to FIG. 5, there is shown a link assembly for use in a slider assembly of a conventional slide type cellular phone having a pair of link plates, which is disclosed in the publication of Korean Utility Model Registration No. 20-0363295. For the purpose of enhancing durability, the link assembly 300 shown in FIG. 5 makes use of a pair of link plates 310 and a pair of tension springs 320 in place of a torsion spring that has been used to maintain the up and down states of a slide plate in the conventional slide type cellular phone. The link plates 310 have an identical shape and are restrained with each other by means of guide protrusions 313 slidably inserted into guide slots 312. A pair of tension springs 320 is retained in place by means of spring locking portions 314 formed at one end of each of the link plates 310. Each of the link plates 310 has a hinge portion 311 with a through-hole, the hinge portion 311 being rotatably attached to a fixed plate or a slide plate of a cellular phone through a pivot pin.

The conventional link assembly 300 of this configuration suffers from a problem in that the spring locking portions 314 of the link plates 310 are often bent and are difficult to manufacture due to their elongated shape and reduced strength. Furthermore, additional components such as the guide protrusions 313 and the like are needed to slidably restrain the link plates. A difficulty is encountered in an assembling process, because the annular end rings of the tension springs 320 are to be fitted to the spring locking portions 314. Moreover, the annular end rings of the tension springs 320 fitted to the spring locking portions 314 may physically interfere with a flexible printed circuit board and may cause damage thereto if they are moved out of place. Particularly, the annular end rings of the tension springs 320 have a great size, which poses a problem in that the link assembly becomes thick and the cellular phone cannot be manufactured into a slim type.

### DETAILED DESCRIPTION OF THE INVENTION

### Technical Problems

It is an object of the present invention to provide a link assembly capable of solving the afore-mentioned problems inherent in the prior art and a slider assembly for a slide type cellular phone having the link assembly.

Another object of the present invention is to provide a slim and easy-to-manufacture link assembly capable of improving the coupling structure between springs and a link plate and a slider assembly for a slide type cellular phone having the link assembly.

### Solution to the Technical Problems

In accordance with one aspect of the present invention, there is provided an extendable and retractable link assembly comprising:

a link plate including a base end portion and at least one spring receiving channel extending from the base end portion in a longitudinal direction of the link plate;

a link frame coupled to the link plate in a removal-free manner, the link frame including a base end portion and at least one spring support rod extending from the base end portion of the link frame into the spring receiving channel of the link plate for sliding movement relative to the spring receiving channel; and

at least one spring having a first end received within the spring receiving channel of the link plate and a second end into which the spring support rod of the link frame is inserted.

In accordance with another aspect of the present invention, there is provided a slider assembly for a slide type cellular phone comprising:

a fixed plate attached to one surface of a body of the cellular phone, the fixed plate having a guide portion;

a sliding plate attached to one surface of a cover of the cellular phone in a facing relationship with the fixed plate, the sliding plate coupled to the fixed plate for rectilinear sliding movement along the guide portion of the fixed plate; and

an extendable and retractable link assembly rotatably attached to the fixed plate and the sliding plate for applying a biasing force to the fixed plate and the sliding plate, wherein the link assembly comprises:

a link plate including a base end portion and at least one spring receiving channel extending from the base end portion in a longitudinal direction of the link plate, the base end portion of the link plate having a through-hole through which a pivot pin is inserted to attach the link plate to one of the fixed plate and the sliding plate;

a link frame coupled to the link plate in a removal-free manner, the link frame including a base end portion and at least one spring support rod extending from the base end portion of the link frame into the spring receiving channel of the link plate for sliding movement relative to the spring receiving channel, the base end portion of the link frame having a through-hole through which a pivot pin is inserted to attach the link frame to the other of the fixed plate and the sliding plate; and

at least one spring having a first end received within the spring receiving channel of the link plate and a second end into which the spring support rod of the link frame is inserted.

### Advantageous Effects

Use of the compression springs in the link assembly of the present invention eliminates the need to form spring locking portions. This makes it possible to manufacture the link assembly by an injection molding method in a simple and easy manner.

With the present invention, it is possible to reduce the thickness of the slider assembly by improving the structure of coupling portions of the link assembly coupled to the slider assembly. This helps make a slide type cellular phone slim.

### BRIEF DESCRIPTION OF THE DRAWINGS

FIG. 1 is a perspective view showing a link assembly in accordance with one embodiment of the present invention.

FIG. 2 is an exploded perspective view of the link assembly shown in FIG. 1.

FIG. 3 is an exploded perspective view showing a slider assembly for a cellular phone provided with the link assembly shown in FIG. 1.

FIGS. 4A, 4B and 4C are views for explaining different operation states of the slider assembly shown in FIG. 3.

FIG. 5 is a perspective view illustrating a conventional link assembly.

### BEST MODE FOR CARRYING OUT THE INVENTION

Preferred embodiments of a link assembly and a slider assembly having the same in accordance with the present invention will be described in detail hereinafter with reference to the accompanying drawings.

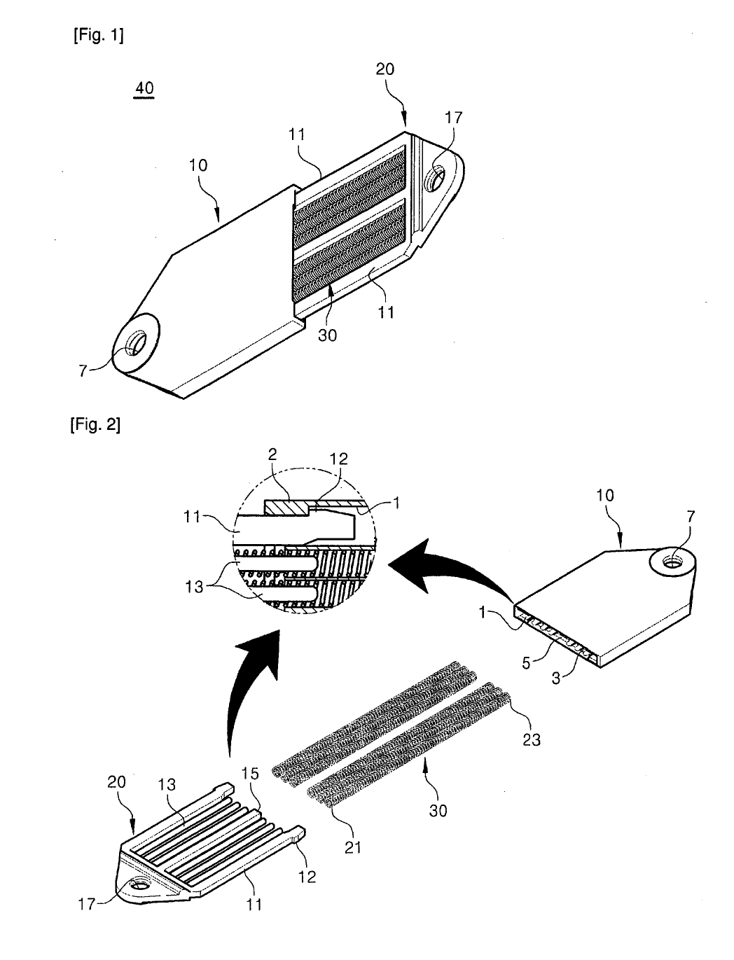

First, description will be made on a link assembly. FIG. 1 is a perspective view showing a link assembly in accordance with one embodiment of the present invention and FIG. 2 is an exploded perspective view of the link assembly shown in FIG. 1.

Referring to FIGS. 1 and 2, the link assembly includes a link plate 10, a link frame 20 and a plurality of springs 30. The link plate 10 has a pair of laterally spaced-apart guide channels 1, a plurality of spring receiving channels 3 arranged between the guide channels 1 and a through-hole formed through the thickness of the link plate 10. A plurality of compression springs 30 is received within the spring receiving channels 3 in a mutually separated state. The spring receiving channels 3 extend from a base end portion of the link plate 10 in a longitudinal direction so that the springs 30 can be received within the spring receiving channels 3. Although the spring receiving channels 3 correspond in number to the springs 30 in the present embodiment, a single wide spring receiving channel for receiving a plurality of springs may be formed to extend in the longitudinal direction of the link plate 10. In this case, a plurality of longitudinally-extending spaced-apart ridges may be formed in the single spring receiving channel so that the springs can be separated from one another by the ridges.

The guide channels 1 are formed at the lateral opposite ends of the link plate 10 to extend along the longitudinal direction of the link plate 10. Stopper juts 2 are formed in the entrance portions of the guide channels 1. The stopper juts 2 are shaped and arranged to engage with the below-mentioned lugs 12 of a guide rods 11, thereby preventing removal of the guide rods 11 from the guide channels 1.

One surface of the base end portion of the link plate 10 is recessed to reduce the thickness of the base end portion. This means that the base end portion of the link plate 10 is thinner than the tip end portion thereof. The through-hole 7 is formed in the base end portion of the link plate 10. A below-mentioned pivot pin 115 is inserted into the through-hole 7 to rotatably secure the link plate 10 to the slider assembly described below. The pivot pin 115 is provided with an enlarged head having a specified thickness. The reason why the thickness of the base end portion of the link plate 10 is reduced by recessing one surface of the base end portion is to provide a space in which the head of the pivot pin 115 can be received without increasing the thickness of the slider assembly as a whole.

The link frame 20 includes a plurality of spring support rods 13, a pair of guide rods 11 and a through-hole 17 formed through the thickness of the link frame. The spring support rods 13 are designed to extend from a base end portion of the link frame 20 in a longitudinal direction and arranged side by side along a transverse direction of the link frame 20 so that they can be slidably inserted into the corresponding spring receiving channels 3 of the link plate 10.

The guide rods 11 are formed at the lateral opposite ends of the link frame 20 so that they can be slidably inserted into the guide channels 1 of the link plate 10. The guide rods 11 are provided at their distal ends with lugs 12 engageable with the stopper juts 2 formed in the guide channels 1 of the link plate 10. When inserted into the guide channels 1, the guide rods 11 allow the link frame 20 to make smooth sliding movement along the link plate 10, at which time the spring support rods 13 make sliding movement within the spring receiving channels 3. As the link frame 20 is slid in such a direction that the spring support rods 13 go out of the spring receiving channels 3, the lugs 12 of the guide rods 11 come into engagement with the stopper juts 2 of the guide channels 1, thereby preventing removal of the link frame 20 from the link plate 10.

One surface of the base end portion of the link frame is recessed to reduce the thickness of the base end portion. The through-hole 17 is formed in the base end portion of the link frame 20. A pivot pin 105 is inserted into the through-hole 17 to rotatably secure the link frame 20 to the slider assembly described below. The direction in which the pivot pin 105 is inserted into the through-hole 17 is opposite from the direction in which the pivot pin 115 is inserted into the through-hole 7. The recessed surface of the base end portion of the link frame 20 is arranged on the opposite side from the recessed surface of the base end portion of the link plate 10 so that the thickness of the slider assembly can be kept small even when the pivot pins 105 and 115 with the enlarged head are inserted into the through-holes 7 and 17.

The springs 30 are received within the spring receiving channels 3 of the link plate 10 and the spring support rods 13 of the link frame 20 are inserted into the corresponding springs 30. In other words, the springs 30 have first ends 23 received within the spring receiving channels 3 and second ends 21 into which the spring support rods 13 are inserted. If the link plate 10 and the link frame 20 are pushed to move toward each other, the link frame 20 is slid toward the link plate 10 while compressing the springs 30. If the pushing force is removed, the link frame 20 is slid away from the link plate 10 into the original position by the pressure of the springs 30.

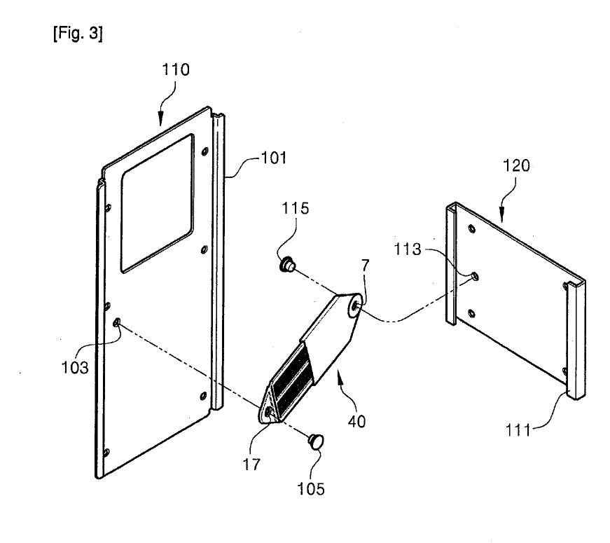

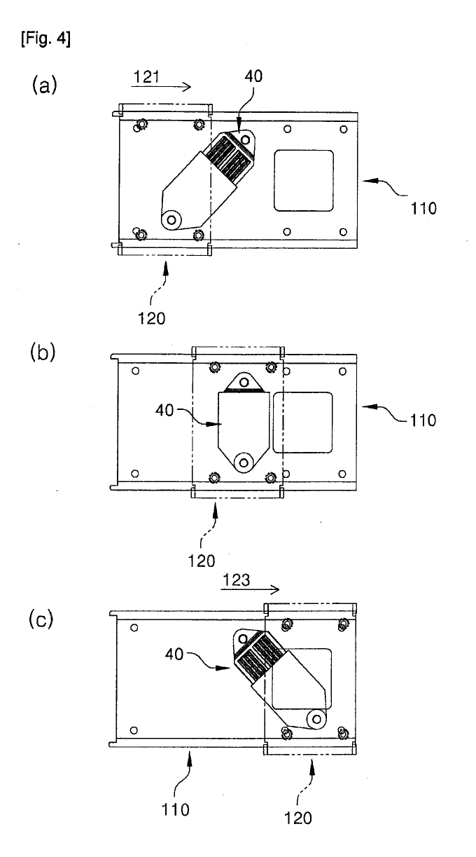

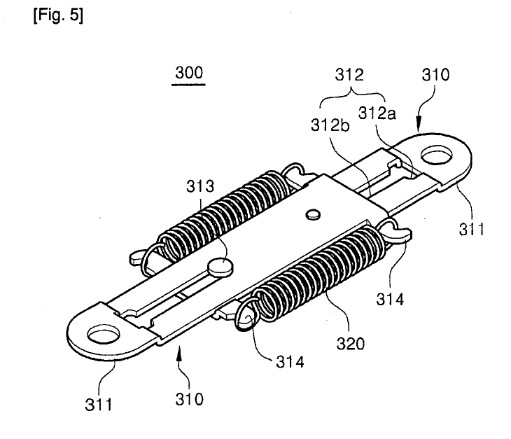

Next, description will be made on the slider assembly. FIG. 3 is an exploded perspective view showing a slider assembly for a cellular phone provided with the link assembly shown in FIG. 1 and FIGS. 4A, 4B and 4C are views for explaining different operation states of the slider assembly shown in FIG. 3.

Referring to FIG. 3, the slider assembly includes a fixed plate 110, a sliding plate 120 and a link assembly 40 for applying a biasing force to the fixed plate 110 and the sliding plate 120. The fixed plate 110 is fixed to one surface (the front surface) of a body of a slide type cellular phone and is provided with guide portions 101 formed on the opposite side edges thereof.

The sliding plate 120 is fixed to one surface (the rear surface) of a cover of the slide type cellular phone in a facing relationship with the fixed plate. The sliding plate 120 is provided with slider portions 111 formed on the opposite side edges thereof. The slider portions 111 are slidably fitted to the guide portions 101 of the fixed plate 110 so that they cam make rectilinear sliding movement along the guide portions 101.

The link assembly 40 is the same one as shown in FIG. 1. The link frame 20 of the link assembly 40 is rotatably attached to the fixed plate 110 of the slider assembly by the pivot pin 105 inserted into the through-hole 17. Likewise, the link plate 10 is rotatably attached to the sliding plate 120 of the slider assembly by the pivot pin 115 inserted into the through-hole 7.

If a force is applied to the sliding plate 120 in the direction designated by an arrow 121 in FIG. 4A, the sliding plate 120 is slid along the fixed plate 110 in the direction of the arrow 121. At this time, the springs 30 are compressed so that a restoring force can be accumulated in the springs 30. When the sliding plate 120 is moved to the position illustrated in FIG. 4B, the springs 30 are compressed into the smallest size, at which time the restoring force accumulated in the springs 30 becomes greatest. If the sliding plate 120 is further pushed in this state, the accumulated restoring force of the springs causes the sliding plate 120 to move in the direction designated by an arrow 123 in FIG. 4C.

The embodiment shown and described hereinabove should not be construed to limit the scope of protection of the present invention. The scope of the invention shall be limited only by the subject matters recited in the claims. It will be understood by those skilled in the art that various changes and modifications may be made without departing from the scope of the invention defined in the claims.

### INDUSTRIAL APPLICABILITY

The link assembly and the slider assembly incorporating the same can be advantageously applied to a slide type cellular phone.

1. An extendable and retractable link assembly comprising:
a link plate including a base end portion and at least one spring receiving channel extending from the base end portion in a longitudinal direction of the link plate;
a link frame coupled to the link plate in a removal-free manner, the link frame including a base end portion and at least one spring support rod extending from the base end portion of the link frame into the spring receiving channel of the link plate for sliding movement relative to the spring receiving channel; and
at least one spring having a first end received within the spring receiving channel of the link plate and a second end into which the spring support rod of the link frame is inserted.

2. The link assembly as recited in claim 1, wherein the link frame further includes at least one guide rod extending parallel to the spring support rod, the guide rod having a lug formed at a tip end thereof, and wherein the link plate further includes at least one removal-proof portion engageable with the lug of the guide rod of the link frame to prevent removal of the link frame from the link plate.

3. The link assembly as recited in claim 2, wherein the removal-proof portion of the link plate includes a guide channel for receiving the guide rod of the link frame, the guide channel having a stopper jut formed at an entrance thereof to engage with the lug of the guide rod of the link frame.

4. The link assembly as recited in claim 3, wherein the spring receiving channel is formed in plural numbers and arranged side by side along a transverse direction of the link plate.

5. The link assembly as recited in claim 4, wherein the guide rod includes a pair of guide rods formed on opposite lateral side portions of the link frame, the guide channel including a pair of guide channels formed on opposite lateral side portions of the link plate.

6. The link assembly as recited in claim 1, wherein the base end portion of the link plate has a surface recessed to reduce the thickness of the link plate and a through-hole formed through the thickness of the link plate, and wherein the base end portion of the link frame has a surface recessed to reduce the thickness of the link frame and a through-hole formed through the thickness of the link frame, the recessed surface of the base end portion of the link plate arranged on the opposite side from the recessed surface of the base end portion of the link frame.

7. A slider assembly for a slide type cellular phone comprising:
a fixed plate attached to one surface of a body of the cellular phone, the fixed plate having a guide portion;
a sliding plate attached to one surface of a cover of the cellular phone in a facing relationship with the fixed plate, the sliding plate coupled to the fixed plate for rectilinear sliding movement along the guide portion of the fixed plate; and
an extendable and retractable link assembly rotatably attached to the fixed plate and the sliding plate for applying a biasing force to the fixed plate and the sliding plate, wherein the link assembly comprises:
a link plate including a base end portion and at least one spring receiving channel extending from the base end portion in a longitudinal direction of the link plate, the base end portion of the link plate having a through-hole through which a pivot pin is inserted to attach the link plate to one of the fixed plate and the sliding plate;
a link frame coupled to the link plate in a removal-free manner, the link frame including a base end portion and at least one spring support rod extending from the base end portion of the link frame into the spring receiving channel of the link plate for sliding movement relative to the spring receiving channel, the base end portion of the link frame having a through-hole through which a pivot pin is inserted to attach the link frame to the other of the fixed plate and the sliding plate; and
at least one spring having a first end received within the spring receiving channel of the link plate and a second end into which the spring support rod of the link frame is inserted.

8. The slider assembly as recited in claim 7, wherein the link frame further includes at least one guide rod extending parallel to the spring support rod, the guide rod having a lug formed at a tip end thereof, and wherein the link plate further includes at least one removal-proof portion engageable with the lug of the guide rod of the link frame to prevent removal of the link frame from the link plate.

9. The slider assembly as recited in claim 8, wherein the removal-proof portion of the link plate includes a guide channel for receiving the guide rod of the link frame, the guide channel having a stopper jut formed at an entrance thereof to engage with the lug of the guide rod of the link frame.

10. The slider assembly as recited in claim 9, wherein the spring receiving channel is formed in plural numbers and arranged side by side along a transverse direction of the link plate.

11. The slider assembly as recited in claim 10, wherein the guide rod includes a pair of guide rods formed on opposite lateral side portions of the link frame, the guide channel including a pair of guide channels formed on opposite lateral side portions of the link plate.

12. The slider assembly as recited in claim 7, wherein the base end portion of the link plate has a surface recessed to reduce the thickness of the link plate and wherein the base end portion of the link frame has a surface recessed to reduce the thickness of the link frame, the recessed surface of the base end portion of the link plate arranged on the opposite side from the recessed surface of the base end portion of the link frame.
